(19) United States
(12) Patent Application Publication
(10) Pub. No.: US 2007/0097234 A1
(43) Pub. Date: May 3, 2007

(54) Apparatus, method and program for providing information

(75) Inventor: Takeshi Katayama, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/453,772

(22) Filed: Jun. 16, 2006

(30) Foreign Application Priority Data
Jun. 16, 2005 (JP) 176350/2005

(51) Int. Cl. H04N 5/262

(52) U.S. Cl. 348/239

(57) ABSTRACT

When various kinds of information is provided by an apparatus in the form of characters or the like, an assistance function is automatically provided for letting a user of the apparatus understand the information. For this purpose, an extraction unit extracts the face of the user from an image obtained by photography of a scene around the apparatus, and a detection unit detects at least one of a face movement, a visual line, and a facial expression of the user. An assistance necessity judgment unit judges whether or not provision of the assistance function is necessary for the user to understand the information, based on a result of the detection by the detection unit. An assistance function provision unit provides the assistance function based on a result of the judgment by the assistance necessity judgment unit.

### BACKGROUND OF THE INVENTION

1. Field of the Invention

The present invention relates to an apparatus and method for providing information by means of characters or voice, and to a program for causing a computer to execute the method.

2. Description of the Related Art

There have been known an apparatus and a system that activates an assistance function through automatic judgment of a person's ability by his/her appearance. For example, a system for moving a mouse pointer has been proposed in Japanese Unexamined Patent Publication No. 2002-323956. In this system, coordinates of a mouse pointer are calculated from movement of facial features such as eyes and mouth of an operator of a computer, and the pointer is moved thereto. In Japanese Unexamined Patent Publication No. 6(1994)-043851 has been proposed a method for converting a direction found to represent a visual line of an operator gazing at a display screen into coordinates of display means and for displaying a predetermined region including the coordinates by enlarging the region in the case where the coordinates do not change for a predetermined time. In addition, a communications simulator has also been proposed in International Patent Publication No. WO2002-037474 for responding to a speaker by judging an emotional state or a characteristic of the speaker based on a direction of gaze (directions of head and eyes), posture (such as leaning forward), a gesture, a facial expression, a speed of speech, intonation, strength of voice, and the like.

Meanwhile, in a system such as an automatic ticket vending machine at a station for guiding how to purchase a ticket by display of characters in a screen, a person can purchase a ticket without a problem by reading the characters written in Japanese if the person is a Japanese. However, if the person is a foreigner who does not understand the Japanese language, the person cannot buy a ticket, since he/she is unable to read the characters displayed on the screen.

### SUMMARY OF THE INVENTION

The present invention has been conceived based on consideration of the above circumstances. An object of the present invention is therefore to automatically provide an assistance function necessary for a user to understand various kinds of information when the information is provided in the form of characters or the like.

An information provision apparatus of the present invention is an information provision apparatus for providing various kinds of information in the form of characters or voice, such as an automatic ticket vending machine or a guiding machine installed in a museum or the like, and the apparatus comprises:

extraction means for extracting the face of a user of the information provision apparatus from an image obtained by photography of a scene around the apparatus;

detection means for detecting at least one of a face movement, a visual line, and a facial expression of the user having been detected;

assistance necessity judgment means for judging whether or not provision of an assistance function is necessary for the user to understand the information, based on a result of the detection by the detection means; and

assistance function provision means for providing the assistance function, based on a result of the judgment by the assistance necessity judgment means.

In the information provision apparatus of the present invention, the information may be provided by display in a predetermined language. In this case, the assistance function provision means may provide the assistance function by changing the predetermined language, based on the result of the judgment.

An information provision method of the present invention is a method for an information provision apparatus that provides various kinds of information, and the method comprises the steps of:

extracting the face of a user of the apparatus from an image obtained by photography of a scene around the apparatus;

detecting at least one of a face movement, a visual line, and a facial expression of the user having been detected;

judging whether or not provision of an assistance function is necessary for the user to understand the information, based on a result of the detection; and

providing the assistance function, based on a result of the judgment.

The information provision method of the present invention may be provided as a program for causing a computer to execute the method.

According to the present invention, the face of a user of the apparatus is extracted from an image obtained by photography of a scene around the apparatus, and at least one of a face movement, a visual line, and a facial expression of the user is detected. Based on the detection result, necessity of provision of the assistance function is judged for letting the user understand the information, and the assistance function is provided based on the judgment result. Therefore, in the case where the user is in trouble or shaking his/her head because he/she does not understand the information, the assistance function can be provided automatically for letting the user understand the information. In this manner, the user can understand the information provided by the apparatus.

### BRIEF DESCRIPTION OF THE DRAWINGS

FIG. 1 is a block diagram showing the configuration of an automatic ticket vending machine adopting an information provision apparatus as an embodiment of the present invention;

FIG. 2 shows an example of a screen displayed on a display unit (in Japanese);

FIG. 3 shows how a face image is extracted;

FIG. 4 shows how an inverse triangle is set on the face image;

FIG. 5 an example of a screen displayed on the display unit (in English);

FIG. 6 is a flow chart showing a procedure for assistance function provision; and

FIG. 7 shows an example of a screen displayed on the display unit (in Japanese and English).

### DESCRIPTION OF THE PREFERRED EMBODIMENT

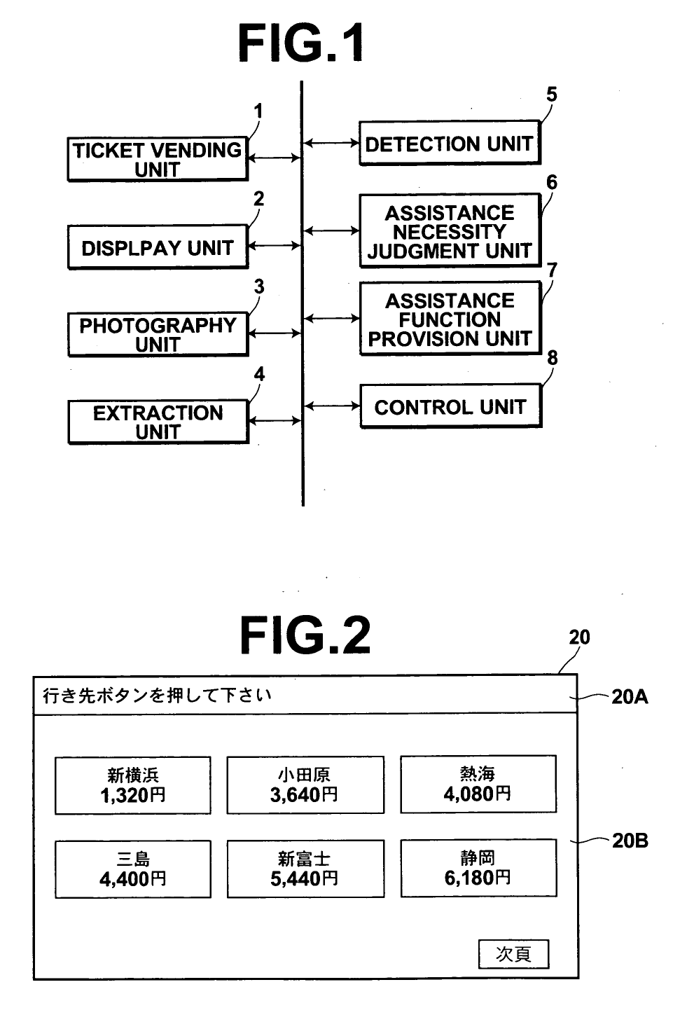

Hereinafter, an embodiment of the present invention will be described with reference to the accompanying drawings. FIG. 1 is a block diagram showing the configuration of an automatic ticket vending machine adopting an information provision apparatus as the embodiment of the present invention. As shown in FIG. 1, the automatic ticket vending machine comprises a ticket vending unit 1, a display unit 2, a photography unit 3, an extraction unit 4, a detection unit 5, an assistance necessity judgment unit 6, an assistance function provision unit 7, and a control unit 8. The ticket vending unit 1 has a function for selling a ticket. The display unit 2 carries out various kinds of display necessary for selling the ticket. The photography unit 3 photographs a user of the machine. The extraction unit 4 extracts the user from an image obtained by photography with the photography unit 3. The detection unit 5 detects a movement, a visual line, and a facial expression of the user having been extracted. The assistance necessity judgment unit 6 judges whether or not provision of an assistance function is necessary for the user, based on a result of the detection by the detection unit 5. The assistance function provision unit 7 provides the assistance function, based on a result of the judgment by the assistance necessity judgment unit 6. The control unit 8 controls the entire machine.

The control unit 8 comprises a control board or a semi-conductor device having inside a CPU and a memory, for example. The memory of the control unit 8 stores an assistance function provision program, and the program controls image display on the display unit 2, photography by the photography unit 3, extraction processing by the extraction unit 4, detection processing by the detection unit 5, judgment processing by the assistance necessity judgment unit 6, and assistance function provision processing by the assistance function provision unit 7.

The ticket vending unit 1 provides various kinds of functions necessary for purchasing a ticket, such as a function for accepting money inserted by the user, a function for receiving input of the type of the ticket desired by the user, a function for issuing the ticket, and a function for providing change.

The display unit 2 comprises a liquid crystal monitor or the like, and carries out the display necessary for selling the ticket, under control of the control unit 8. FIG. 2 shows an example of a screen displayed on the display unit 2. As shown in FIG. 2, a help message area 20A and a button area 20B are displayed in a display screen 20. A help message reading “Push the button for your destination” is displayed in the help message area 20A. In the button area 20B are displayed a plurality of buttons representing destinations and fares therefor. A button “Next” is also shown in the button area 20B, and the user can display destination buttons other than the destination buttons currently displayed, by touching the “Next” button.

The photography unit 3 comprises a lens for photography, a CCD, an A/D converter, and the like, and photographs a scene around the machine for obtaining digital moving image data S0. In order to photograph the face of the user operating the display unit 2, the photography unit 3 is installed in the vending machine in the same direction as the screen of the display unit 2.

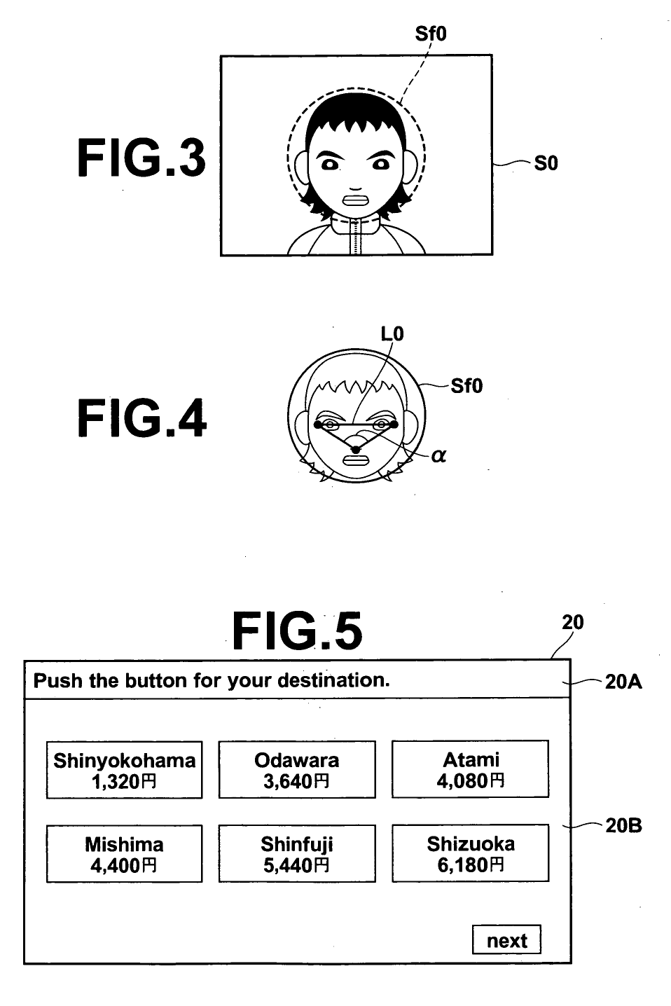

The extraction unit 4 extracts a face image Sf0 of the user from an image represented by the image data S0 (hereinafter the image and the image data are represented by the same reference code) obtained by the photography unit 3. As a method of extraction of the face image Sf0, any known method can be used. For example, a region of skin color may be detected in the image S0 so that a region in a predetermined range including the skin-color region can be extracted as the face image Sf0. Alternatively, the face may be detected based on features such as the eyes, the nose, and the mouth included in the face so that a region in a predetermined range including the face can be extracted as the face image Sf0. In this manner, the face image Sf0 of the user is extracted from the image S0 as shown in FIG. 3, for example.

Since the image S0 is a moving image, the extraction unit 4 extracts frames at predetermined intervals from all frames comprising the moving image, and extracts the face image Sf0 from each of the extracted frames.

The detection unit 5 detects a movement, a visual line, and a facial expression of the user, by using the extracted face image Sf0. Firstly, detection of a face movement is described below.

The detection unit 5 detects positions of outer corners of the eyes and the nose tip included in the face image Sf0 as shown in FIG. 4, and sets an inverse triangle on the face image Sf0. Based on a shape and a change in the shape of the inverse triangle, the face movement is detected. For example, a vertex angle α of the triangle shown in FIG. 4 is compared with a threshold value Th1 set for distinction between a state of looking straight and a state of looking sideways. In the case where the angle α is not smaller than the threshold value Th1, the user is judged to be looking straight. Otherwise, the person is judged to be looking sideways. For judgment as to whether the face has moved after the judgment of the direction of the face, the vertex angle α is compared again with the threshold value Th1 in the inverse triangle set in the face image Sf0 extracted from another one of the frames separated by a time interval of t1. In the case where the user has been judged to be still looking straight, the face of the user is judged to be looking straight and stationary. In the case where the user has been judged to be still looking sideways, the face of the user is judged to be looking sideways and stationary. In the case where the user has been judged to be looking sideways after having been judged to be looking straight, or vise versa, the user is judged to be shaking his/her head.

Furthermore, whether the face of the user is tilted is judged by judging whether a base L0 of the inverse triangle is horizontally stationary or tilted.

Since the image S0 is a moving image, the face movement may be detected according to a neural network that has learned to output information on face movement (such as stationary and looking straight, stationary and looking sideways, shaking head, or inclining head) by using input of a characteristic vector representing the face movement detected from the face image Sf0 extracted from the frames neighboring each other in terms of time.

Extraction of the visual line is described next. The detection unit 5 detects the eyes and pupils of the user from the face image Sf0, and detects a movement of the pupils. Since the image S0 is a moving image, the visual line can be detected according to a neural network that has learned to output information on the pupil movement (such as stationary and looking straight, stationary and looking sideways, looking around restlessly, or moving sideways at a constant speed) by using input of a characteristic vector representing the pupil movement in the face image Sf0 extracted from the frames neighboring each other in terms of time. In the case where the pupils have been judged to be moving sideways at a constant speed, it is inferred that the user is reading the characters displayed on the display unit 2.

Detection of the facial expression is described next. The detection unit 5 detects the eyes in the face image Sf0, and judges whether the eyes are open or closed or half closed. A facial expression is then detected according to a neural network that has learned to output information on the facial expression (such as in trouble, in thought, or in a normal expression) by using input of the information on the state of the eyes and the information representing the visual line movement.

The detection unit 5 detects the face movement, the visual line, and the facial expression of the user, and outputs the information thereon as has been described above.

The assistance necessity judgment unit 6 judges whether provision of the assistance function is necessary for the user to understand the display on the display unit 2. In the case where the face is looking straight and stationary with a normal facial expression while the visual line is moving sideways at a constant speed, the user is judged to be reading the characters displayed on the display unit 2. In the case where the visual line is not toward the display unit 2 while the face is looking straight with a troubled expression, the user is judged to be unable to read the characters displayed on the display unit 2. In the case where the visual line is moving slowly, the speed of reading the characters is slow. Therefore, the user is judged to have difficulty in reading the characters displayed on the display unit 2.

The assistance necessity judgment unit 6 stores an evaluation function for finding information representing whether or not the characters are being read, based on the information on the face movement, the visual line, and the facial expression. By using the information found according to the evaluation function, the assistance necessity judgment unit 6 judges whether or not the user is reading the characters. This judgment may be made based on output from a neural network stored to output the information on whether the characters are being read by using the information on the face movement, the visual line, and the facial expression as input. The assistance necessity judgment unit 6 judges that provision of the assistance function is not necessary in the case where the user has been judged to be reading the characters. Otherwise, the assistance necessity judgment unit 6 judges that the provision of the assistance function is necessary.

The assistance function provision unit 7 provides the assistance function based on the result of judgment by the assistance necessity judgment unit 6. More specifically, in the case where the assistance necessity judgment unit 6 has judged that the assistance function needs to be provided, the language of the characters shown in the display unit 2 is changed from Japanese shown in FIG. 2 to English shown in FIG. 5.

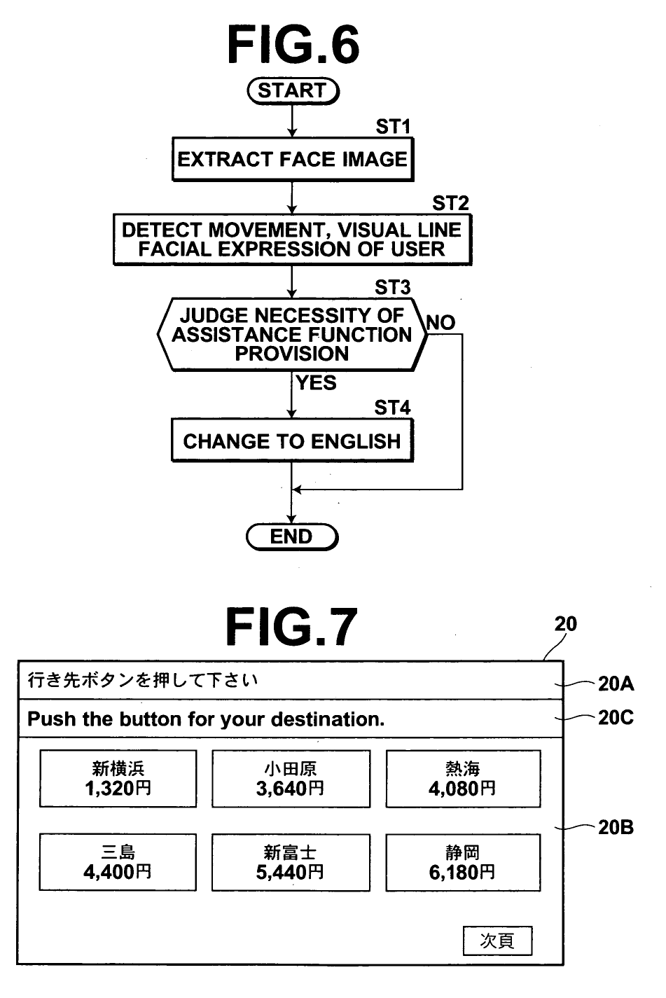

A procedure in the assistance function provision in the automatic ticket vending machine in this embodiment will be described next. FIG. 6 is a flow chart showing the procedure. In the automatic ticket vending machine in this embodiment, the display screen 20 shown in FIG. 2 is displayed as an initial screen on the display unit 2.

The control unit 8 starts the procedure when the photography unit 3 obtains the image S0 by photography of the user, and the extraction unit 4 extracts the face image Sf0 in the image S0 (Step ST1). The detection unit 5 detects the movement, the visual line, and the facial expression of the user by using the extracted face image Sf0 (Step ST2). The assistance necessity judgment unit 6 judges whether the assistance function needs to be provided for the user to understand the display on the display unit 2, based on the information on the movement, the visual line, and the facial expression of the user (Step ST3).

If a result of judgment at Step ST3 is affirmative because the user needs provision of the assistance function, the assistance function provision unit 7 changes the language of the display screen 20 shown in the display unit 2 to English (Step ST4) to end the procedure. If the result of judgment at Step ST3 is negative because provision of the assistance function is not necessary, the procedure also ends.

As has been described above, in this embodiment, the assistance function for letting the user understand the information, that is, the change in the displayed language, can be provided automatically in the case where the user is at a loss or shaking his/her head because he/she does not understand the information in characters displayed on the display unit 2. Consequently, the user can understand the information displayed on the display unit 2.

In the above-described embodiment, the information provision apparatus of the present invention is applied to the automatic ticket vending machine. However, the information provision apparatus of the present invention can be applied to various information provision apparatuses such as a vending machine of another type or a guiding machine installed in a museum that provides information in the form of character display.

In the embodiment described above, necessity of provision of the assistance function is judged by using all the face movement, the visual line, and the facial expression of the user. However, the necessity may be judged from at least one of the face movement, the visual line, and the facial expression of the user.

In the embodiment, the neural networks are used for detection of the face movement, the visual line, and the facial expression of the user, as well as for the judgment of necessity of the assistance function provision. However, as long as a result of machine learning is used, the neural networks are not necessarily used.

In the above-described embodiment, the information is provided in the form of characters. However, in the case where the information is provided by means of voice, an assistance function for changing the language of the voice may also be provided. In the case where the information is provided as the characters and as the voice, an assistance function is provided for changing the language of the characters and the voice.

In the embodiment, the language to be displayed is changed. However, as shown in FIG. 7, a help area 20C may also be displayed in the display screen 20 so that the help message in English can be displayed therein.

Although the information provision apparatus of the embodiment of the present invention has been described above, a program causing a computer to function as the extraction unit 4, the detection unit 5, the assistance necessity judgment unit 6, and the assistance function provision unit 7 for carrying out the procedure shown in FIG. 6 is also another embodiment of the present invention. A computer-readable recording medium storing the program is also an embodiment of the present invention.

What is claimed is:

1. An information provision apparatus for providing various kinds of information, the apparatus comprising:
extraction means for extracting the face of a user of the information provision apparatus from an image obtained by photography of a scene around the apparatus;
detection means for carrying out detection of at least one of a face movement, a visual line, and a facial expression of the user having been detected;
assistance necessity judgment means for carrying out judgment as to whether or not provision of an assistance function is necessary for the user to understand the information, based on a result of the detection by the detection means; and
assistance function provision means for providing the assistance function, based on a result of the judgment by the assistance necessity judgment means.

2. The information provision apparatus according to claim 1, wherein the various kinds of information is provided by display in a predetermined language and the assistance function provision means provides the assistance function by changing the predetermined language based on the result of the judgment.

3. The information provision apparatus according to claim 1 installed in an automatic ticket vending machine.

4. The information provision apparatus according to claim 1 wherein the assistance necessity judgment means carries out the judgment by using a result of learning according to a machine learning method.

5. An information provision method for an information provision apparatus providing various kinds of information, the method comprising the steps of:
extracting the face of a user of the apparatus from an image obtained by photography of a scene around the apparatus;
carrying out detection of at least one of a face movement, a visual line, and a facial expression of the user having been detected;
carrying out judgment as to whether or not provision of an assistance function is necessary for the user to understand the information, based on a result of the detection; and
providing the assistance function, based on a result of the judgment.

6. The information provision method according to claim 5, wherein provision of the various kinds of information is carried out by display in a predetermined language and the step of providing the assistance function is the step of providing the assistance function by changing the predetermined language based on the result of the judgment.

7. The information provision method according to claim 5 wherein the step of carrying out the judgment is the step of carrying out the judgment by using a result of learning according to a machine learning method.

8. A program for causing a computer to execute an information provision method in an information provision apparatus providing various kinds of information, the program comprising the steps of:
extracting the face of a user of the apparatus from an image obtained by photography of a scene around the apparatus;
carrying out detection of at least one of a face movement, a visual line, and a facial expression of the user having been detected;
carrying out judgment as to whether or not provision of an assistance function is necessary for the user to understand the information, based on a result of the detection; and
providing the assistance function, based on a result of the judgment.

9. The program according to claim 8, wherein provision of the various kinds of information is carried out by display in a predetermined language and the step of providing the assistance function is the step of providing the assistance function by changing the predetermined language based on the result of the judgment.

10. The program according to claim 8 wherein the step of carrying out the judgment is the step of carrying out the judgment by using a result of learning according to a machine learning method.
